(19) United States
(12) Patent Application Publication
(10) Pub. No.: US 2026/0148412 A1
(43) Pub. Date: May 28, 2026

(54) ELECTRONIC DEVICE, CONTROL METHOD FOR THE ELECTRONIC DEVICE, AND MEDIUM

(71) Applicant: CANON KABUSHIKI KAISHA, Tokyo (JP)

(72) Inventor: YASUYUKI SUZUKI, Kanagawa (JP)

(21) Appl. No.: 19/384,209

(22) Filed: Nov. 10, 2025

(30) Foreign Application Priority Data
Nov. 28, 2024 (JP) 2024-207380

(51) Int. Cl. G06T 7/73; G06F 3/01

(52) U.S. Cl. CPC G06T 7/73; G06F 3/013; G06T 2207/10048; G06T 2207/30201

(57) ABSTRACT

An electronic device includes a plurality of irradiation units configured to irradiate an eyeball of a user with infrared light, an image capturing unit configured to capture an ocular image obtained when the infrared light from the plurality of irradiation units is reflected by the eyeball, one or more memories, and one or more processors in communication with the one or more memories. The one or more processors and the one or more memories are configured to calculate a line-of-sight position of the user who looks into a display unit based on combinations of corneal reflection images contained in the ocular image and to set an order with regard to each of the combinations of the corneal reflection images based on a predetermined condition during calibration processing for improving a calculation accuracy of the line-of-sight position.

### BACKGROUND

### Field of the Technology

The present disclosure relates to an electronic device, a control method for the electronic device, and a medium.

### Description of the Related Art

In recent years, an electronic device that uses line-of-sight information of a user as a user interface has been used in various fields. An example of the electronic device of this type includes a digital still camera and a head mount display (HMD). In such an electronic device, a line of sight of a user who looks at a display unit can be detected, and various types of processing can be executed based on a line-of-sight position corresponding to the detected line of sight.

As a method of detecting the line of sight, a corneal reflection method has been proposed. According to this corneal reflection method, an eyeball is irradiated with infrared light from an illumination light source, an ocular image obtained from the infrared light reflected from the eyeball is captured by an image capturing element for the eyeball, so that it is possible to detect the line of sight of the user who looks at a display unit.

Japanese Patent Laid-Open No. 6-125874 describes a technology with which, when a result of line of sight calculated based on a corneal reflection image (P-image) pair that is selected first is clearly abnormal, in a case where there are additional candidate P-image pairs, line-of-sight calculation is attempted by using another P-image pair.

When the number of lit illumination light sources is high, since a probability of accurate determination of an imaging magnification of an ocular image is increased, a line-of-sight detection accuracy is improved. However, when the number of lit illumination light sources is high, the captured ocular image contains a plurality of P-image pairs, and it is difficult to find out which P-image pair is to be used to calculate the line of sight. Then, when the line of sight is calculated from each of the plurality of P-image pairs, it may take time to calculate the line of sight for a result that is clearly normal.

### SUMMARY

In view of the above, embodiments of the present disclosure are aimed to make a line-of-sight detection accuracy less likely to be reduced even when a period of time spent for line-of-sight detection processing is a predetermined period of time, in a case where there are a plurality of combinations (P-image pairs) of corneal reflection images contained in an ocular image.

To achieve the above-described aim, according to an aspect of the present disclosure, there is provided an electronic device including a plurality of irradiation units configured to irradiate an eyeball of a user with infrared light, an image capturing unit configured to capture an ocular image obtained when the infrared light from the plurality of irradiation units is reflected by the eyeball, one or more memories, and one or more processors in communication with the one or more memories. The one or more processors and the one or more memories are configured to calculate a line-of-sight position of the user who looks into a display unit based on combinations of a plurality of corneal reflection images contained in the ocular image and to set an order with regard to each of the combinations of the plurality of corneal reflection images based on a predetermined condition during calibration processing for improving a calculation accuracy of the line-of-sight position. Processing using the combinations of the plurality of corneal reflection images is performed based on the set order within a predetermined time period to calculate the line-of-sight position of the user who looks into the display unit.

Features of various embodiments of the present disclosure will become apparent from the following description of embodiments with reference to the attached drawings. The following description of embodiments is described by way of example.

### BRIEF DESCRIPTION OF THE DRAWINGS

FIG. 1A is a perspective view illustrating an external appearance example of a digital still camera that is an example of an electronic device according to a first embodiment.

FIG. 1B is a perspective view illustrating an external appearance example of the digital still camera that is an example of the electronic device according to the first embodiment.

FIG. 2 is a cross sectional view illustrating a configuration example of the digital still camera that is an example of the electronic device according to the first embodiment.

FIG. 3 is a block diagram illustrating a configuration example of the digital still camera that is an example of the electronic device according to the first embodiment while focusing on an electric circuit.

FIG. 4A illustrates an example of a viewfinder image observed through an eyepiece lens.

FIG. 4B illustrates an example of the viewfinder image observed through the eyepiece lens.

FIG. 4C illustrates an example of the viewfinder image observed through the eyepiece lens.

FIG. 5 is an explanatory diagram for describing a principle of line-of-sight detection.

FIG. 6A is a schematic diagram of an ocular image formed by a light receiving lens.

FIG. 6B is a schematic diagram of a luminance distribution in an area.

FIG. 7 is a flowchart related to line-of-sight detection processing in a case where there is one P-image pair.

FIG. 8 is a flowchart related to calibration processing.

FIG. 9 illustrates a situation where three corneal reflection images are projected onto an eyeball.

FIG. 10A is a flowchart related to a subroutine of rearranging of P-image pairs.

FIG. 10B is a flowchart related to the subroutine of rearranging of the P-image pairs.

FIG. 10C is a flowchart related to the subroutine of rearranging of the P-image pairs.

FIG. 10D is a flowchart related to the subroutine of rearranging of the P-image pairs.

FIG. 10E is a flowchart related to the subroutine of rearranging of the P-image pairs.

FIG. 11 is a flowchart related to line-of-sight detection processing in a case where there are a plurality of P-image pairs.

FIG. 12 is a perspective view illustrating an external appearance example of a head mount display (HMD) that is an example of the electronic device according to a second embodiment.

FIG. 13 is a block diagram illustrating a system configuration example of the HMD that is an example of the electronic device according to the second embodiment.

### DESCRIPTION OF THE EMBODIMENTS

Hereinafter, example embodiments of the present disclosure will be described with reference to the accompanying drawings.

### First Embodiment

### Description on External Appearance

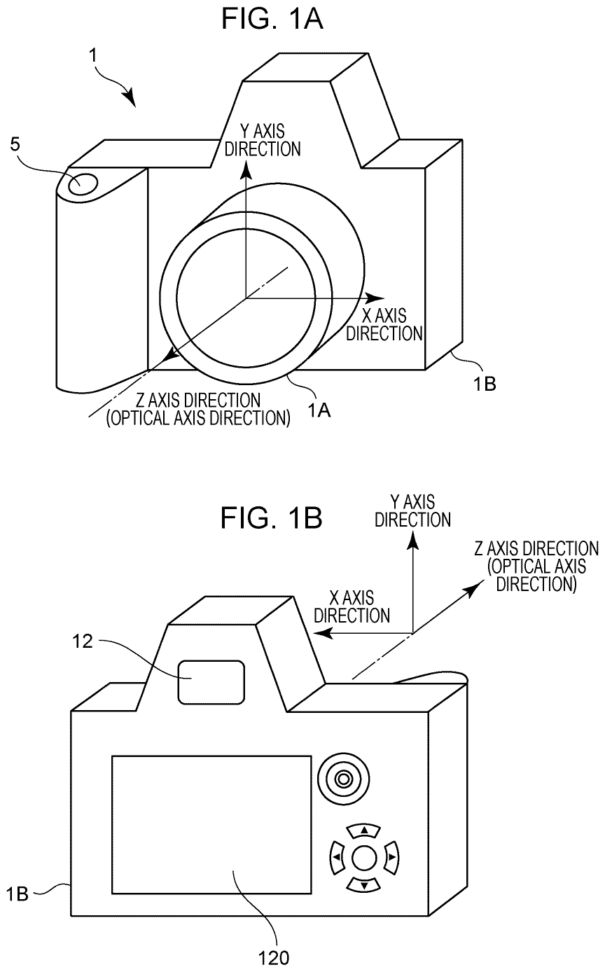

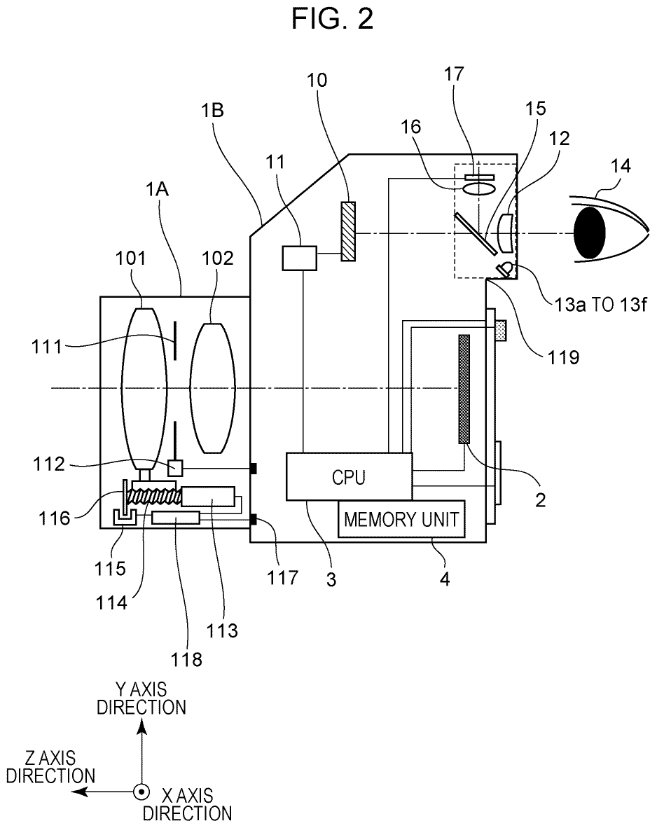

FIGS. 1A and 1B are perspective views illustrating external appearance examples of a digital still camera (hereinafter, referred to as a “camera”) 1 according to a first embodiment, in which FIG. 1A is a perspective view as viewed from a front side, and FIG. 1B is a perspective view as viewed from a rear side.

In FIGS. 1A and 1B, an XYZ orthogonal coordinate system is defined as a camera coordinate system in which an optical axis of a lens unit 1A is represented by a Z axis, an axis in a vertical direction orthogonal to the Z axis is represented by a Y axis, and an axis orthogonal to the Z axis and the Y axis is represented by an X axis. It is noted that an origin of the camera coordinate system may be, for example, an intersecting point of an image sensing surface and the optical axis, but is not limited to this.

The camera 1 includes a camera main unit 1B and the lens unit 1A detachably attached to the camera main unit 1B. A release button 5 is an operation member configured to accept an image capturing instruction from a user. The operation member such as the release button 5 will be hereinafter referred to as an “operation unit”. An eyepiece lens 12 for the user to look into a display element which will be described below and is included inside the camera 1 is arranged on a back of the camera 1, and the user can visibly recognize a field-of-view image by looking into the eyepiece lens 12.

### Description on Configuration

FIG. 2 is a cross sectional view illustrating a configuration example of the camera 1 that is an example of the electronic device according to the present embodiment. FIG. 2 is a cross sectional view of the camera 1 cut along a YZ plane formed by the Y axis and the Z axis illustrated in FIGS. 1A and 1B.

In FIGS. 1A and 1B and FIG. 2, corresponding components are allocated with the same reference numerals.

When the lens unit 1A is mounted to the camera main unit 1B, the lens unit 1A and the camera main unit 1B are electrically connected to each other through a mount contact 117. The lens unit 1A is supplied with electric power from the camera main unit 1B through the mount contact 117. In addition, a circuit in the lens unit 1A and a central processing unit (CPU) 3 of the camera main unit 1B can communicate with each other through the mount contact 117.

The lens unit 1A includes a movable lens 101 and a fixed lens 102. In FIG. 2, each is illustrated as a single lens but is actually constituted by a plurality of lenses.

Herein, the movable lens 101 is a focus lens but may include other movable lenses such as a variable magnification lens and an image stabilization lens.

The movable lens 101 is supported by a lens driving member 114 and driven by a lens driving motor 113 in an optical axis direction (left and right direction of the drawing). A rotation of a pulse plate 116 which is linked with the lens driving member 114 is sensed by a photo coupler 115, and a result is output to a focus adjustment circuit 118. The focus adjustment circuit 118 can detect a drive amount and a drive direction of the movable lens 101 based on the output of the photo coupler 115. When the drive amount and the drive direction of the movable lens 101 are instructed from the CPU 3 of the camera main unit 1B, the focus adjustment circuit 118 controls an operation of the lens driving motor 113 based on the output of the photo coupler 115.

In the camera main unit 1B, an image capturing element 2 is a CCD image sensor or a CMOS image sensor. A plurality of pixels are two-dimensionally arranged in the image capturing element 2, and a single microlens, a single color filter, and one or more photoelectric conversion units are provided in each pixel. In the present embodiment, a configuration is adopted in which a plurality of photoelectric conversion units are provided in each pixel, and a signal can be read out for each photoelectric conversion unit. By adopting such a pixel configuration, a captured image, a parallax image pair, and an image signal for phase difference autofocus (AF) can be generated based on a signal read out from the image capturing element 2. The image capturing element 2 converts an optical image formed by the lens unit 1A into a pixel signal group (analog image signal) through photoelectric conversion by a plurality of pixels. In addition, according to the present embodiment, the image capturing element 2 has an analog-to-digital (A/D) conversion function and converts and outputs the analog image signal into digital image data.

A memory unit 4 includes a non-volatile memory (ROM) and a volatile memory (RAM). By reading a program stored in the ROM into the RAM to execute the program, the CPU 3 controls operations of the camera main unit 1B and the lens unit 1A to realize a function of the camera. In addition, the memory unit 4 includes a medium (such as a memory card) configured to store image data and audio data obtained by image capturing. The CPU 3 controls operations of the focus adjustment circuit 118 and an aperture driving unit 112 through the mount contact 117.

The non-volatile memory of the memory unit 4 may be rewritable. The non-volatile memory stores a program to be executed by the CPU 3, various setting values, image data of a graphical user interface (GUI), line-of-sight correction data for correcting an individual difference in the line of sight, and the like.

A display element 10 is a liquid crystal display (LCD) or an organic electroluminescent (EL) display panel and displays a captured image (e.g., a live-view image), a menu screen, various information, and the like.

A display element driving circuit 11 controls the display element 10 under the control of the CPU 3. Since the display element 10 is provided inside the camera main unit 1B, an eyepiece unit configured to observe the display element 10 from the outside of the camera main unit 1B is provided. An eyepiece unit 119 is provided with the eyepiece lens 12 and illumination light sources 13a to 13f for line-of-sight detection. In addition, the eyepiece unit 119 is provided with a beam splitter 15, a light receiving lens 16, and an image capturing element for eyeball 17, which are configured to capture an ocular image.

The illumination light sources 13a to 13f are a plurality of infrared light emitting diodes (LEDs) arranged around the eyepiece lens 12, and the illumination light sources 13a to 13f illuminate an eyeball 14 of the user who looks into the eyepiece unit with infrared light. An ocular image obtained when infrared light of the illumination light sources 13a to 13f is reflected by the eyeball 14 is reflected by the beam splitter 15 and captured by the image capturing element for eyeball 17 via the light receiving lens 16 provided above. The light receiving lens 16 sets a pupil of the eyeball 14 of the user and the image capturing element for eyeball 17 to be positioned in a conjugate imaging relationship. The image capturing element for eyeball 17 includes a plurality of two-dimensionally arranged pixels and is configured to capture an infrared image. The number of pixels of the image capturing element for eyeball 17 may be less than the number of pixels of the image capturing element 2. The line of sight of the eyeball 14 can be detected based on a positional relationship between corneal reflection and the pupil in the ocular image obtained by the image capturing element for eyeball 17.

### Description on Block Diagram

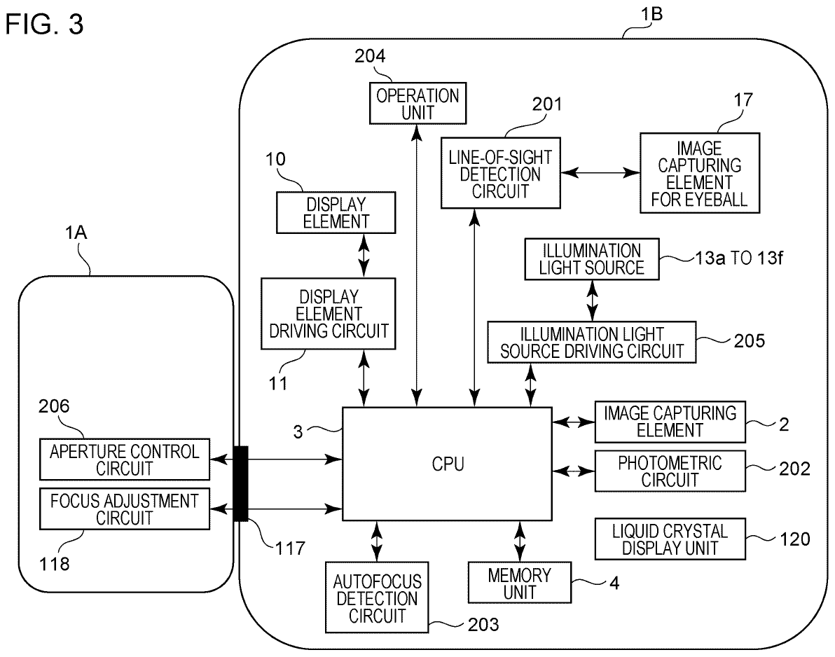

FIG. 3 is a block diagram illustrating a configuration example of the camera 1 of the first embodiment while focusing on an electric circuit. A line-of-sight detection circuit 201, a photometric circuit 202, an autofocus detection circuit 203, an operation unit 204, the display element driving circuit 11, an illumination light source driving circuit 205, and a liquid crystal display unit 120 are connected to the CPU 3. In addition, the focus adjustment circuit 118 and an aperture control circuit 206 (included in the aperture driving unit 112), which are provided in an imaging lens 1, are electrically connected to the CPU 3 through the mount contact 117.

The line-of-sight detection circuit 201 performs A/D conversion of the analog image signal of the ocular image obtained from the image capturing element for eyeball 17 into digital image data and transmits the digital image data to the CPU 3. The CPU 3 detects feature points used for line-of-sight detection based on the digital image data of the ocular image following a related-art algorithm and detects a line-of-sight position of the user based on a position of each of the feature points.

The photometric circuit 202 generates luminance information as a previously set evaluation value for exposure control based on the image data obtained from the image capturing element 2 and outputs the luminance information to the CPU 3. The CPU 3 performs automatic exposure control (AE) processing based on the luminance information and decides an image capturing condition. The image capturing condition is, for example, a shutter speed, an F-number, and a sensitivity in a case of still image capturing. The CPU 3 controls an F-number (aperture amount) of an aperture 111 of the imaging lens 1 based on the decided image capturing condition. In addition, the CPU 3 controls an operation of a mechanical shutter in a main unit 20.

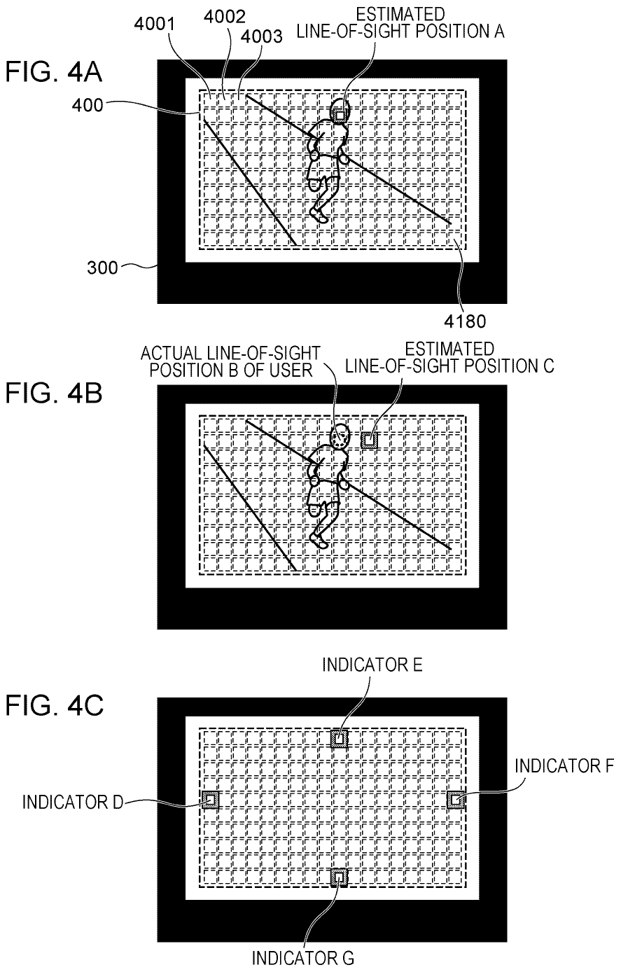

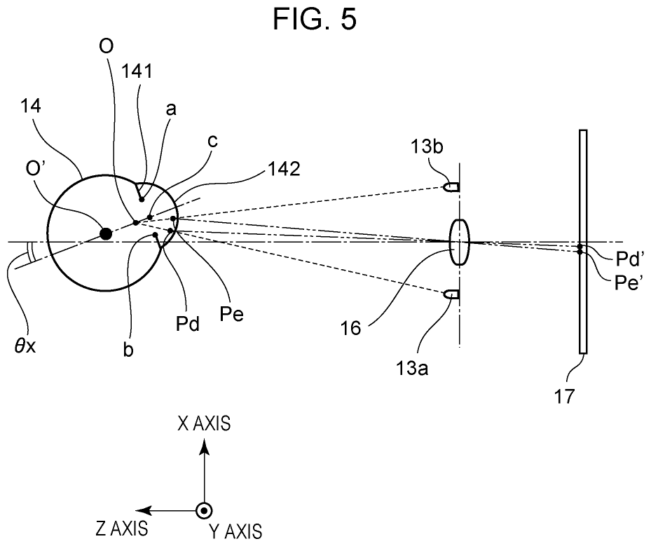

The autofocus detection circuit 203 generates an image signal for phase difference AF based on the image data obtained from the image capturing element 2 and outputs the image signal to the CPU 3. The CPU 3 calculates a defocus amount based on a phase difference of the image signal for phase difference AF. This is a technique in related art which is proposed as image sensing surface phase difference AF. According to the present embodiment, as an example, it is assumed that 180 focus detection points are set at positions on the image sensing surface corresponding to locations indicated by viewfinder images (which will be described below) of FIGS. 4A to 4C, but the configuration is not limited to this.

The operation unit 204 is a generic term of a plurality of input devices that can be operated by the user (such as a button, a switch, and a dial), including the release button 5 which has been described above. When an operation of the input device is detected, the CPU 3 executes processing according to the detected operation.

The release button 5 includes a first shutter switch (SW1) which turns ON when being in a half press state and a second shutter switch (SW2) which turns ON when being in a full press state. When the CPU 3 detects the SW1 is ON, the CPU 3 executes a preparation operation of still image capturing. The preparation operation includes AE processing, AF processing, and the like. In addition, when the CPU 3 detects ON of the SW2, the CPU 3 executes a recording operation and still image capturing following image capturing condition decided in the AE processing.

The illumination light source driving circuit 205 controls light emitting operations of the illumination light sources 13a to 13f under the control of the CPU 3.

The liquid crystal display unit 120 performs display according to a signal from the CPU 3 on a display, such as an LCD or an organic EL.

FIGS. 4A to 4C illustrate examples of a viewfinder image according to the present embodiment. Herein, the viewfinder image is an image which is displayed on the display element 10 and on which various indicators are overlapped. The user can observe the viewfinder image of FIGS. 4A to 4C through the eyepiece lens 12. FIGS. 4A to 4C illustrate a viewfinder field of view representing a state in which the display element 10 operates.

In FIG. 4A, a field-of-view mask 300, an indicator 400 indicating a range in which focus detection can be performed, and 180 indicators (AF frames) 4001 to 4180 at locations corresponding to points where focus detection can be performed (focus detection points) are displayed in the viewfinder image. In addition, an AF frame corresponding to a current line-of-sight position among those AF frames is highlighted to be displayed as an estimated line-of-sight position A. Herein, the estimated line-of-sight position A highlighted to be displayed in FIG. 4A is an image displayed based on the estimated line-of-sight position.

### Description Related to Line-of-Sight Detection

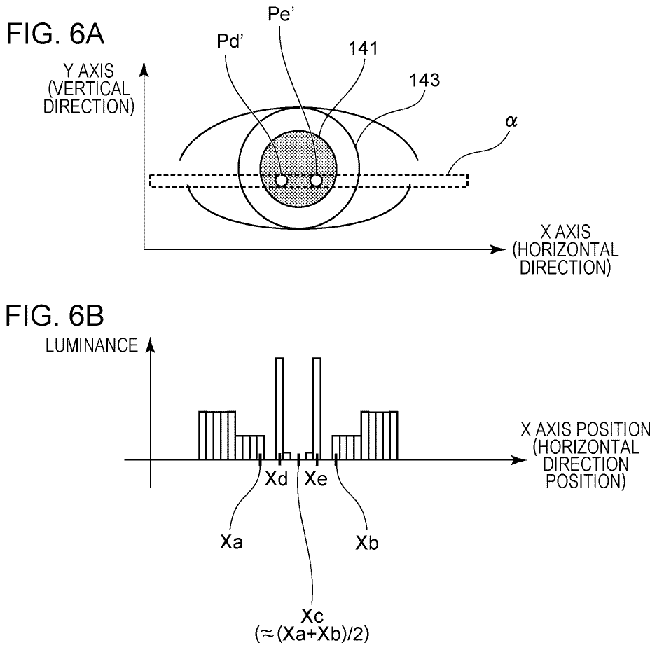

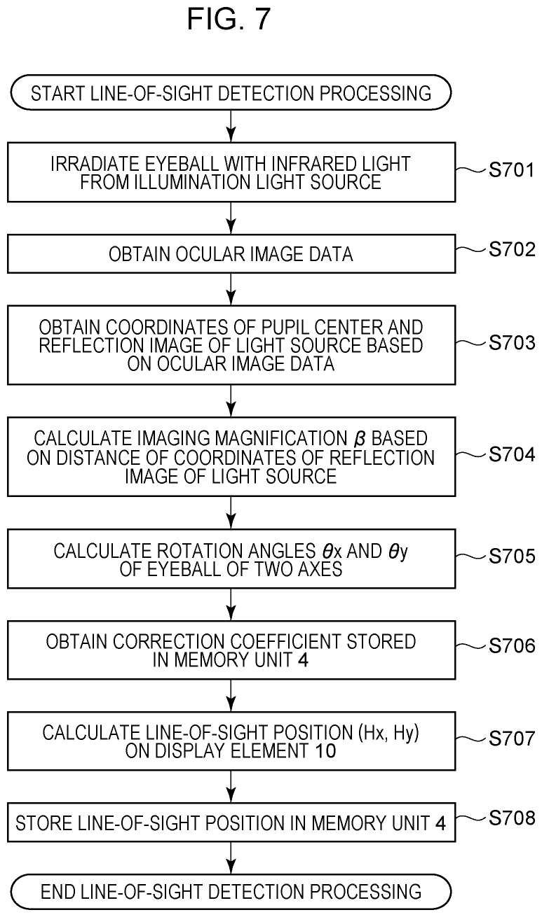

Line-of-sight detection will be described with reference to FIG. 5, FIGS. 6A and 6B, and FIG. 7.

FIG. 5 is an explanatory diagram for describing a principle of line-of-sight detection. In FIG. 2, the image capturing element is arranged such that an optical axis of the image capturing element for eyeball 17 is set in a vertical direction with respect to an optical axis of the eyeball 14. On the other hand, in FIG. 5, for convenience, the optical axis of the image capturing element for eyeball 17 is set in a horizontal direction with respect to the optical axis of the eyeball 14. The illumination light sources 13a to 13f are arranged approximately symmetrically with respect to an optical axis of the light receiving lens 16 and irradiate the eyeball 14 of the user with infrared light. FIG. 5 illustrates only the illumination light sources 13a and 13b. The light receiving lens 16 forms an infrared ocular image reflected by the eyeball 14 on the image sensing surface of the image capturing element for eyeball 17.

FIG. 6A is a schematic diagram of the ocular image formed by the light receiving lens 16, and FIG. 6B is a schematic diagram of a luminance distribution in an area a in FIG. 6A.

Flowchart Related to Line-of-Sight Detection Processing in a Case where there is a Single P-Image Pair

FIG. 7 is a flowchart related to line-of-sight detection processing in a case where there is a single combination (P-image pair) of corneal reflection images contained in an ocular image according to the present embodiment. The line-of-sight detection processing can be executed, for example, when an object is in proximity to the eyepiece lens 12. Proximity of the object to the eyepiece lens 12 can be sensed by any method in related art, such as using, for example, a proximity sensor provided near the eyepiece lens 12. The line-of-sight detection processing may be started in response to an instruction of the user through the operation unit 204. The processing in FIG. 7 is executed when the CPU 3 controls each unit.

In S701, the CPU 3 causes the illumination light sources 13a and 13b illustrated in FIG. 5 to turn on through the illumination light source driving circuit 205. With this configuration, infrared light is emitted from the illumination light sources 13a and 13b towards the outside of the camera main unit 1B. Infrared light is reflected by the eyeball of the user who looks into the eyepiece lens 12 and is further reflected by the beam splitter 15 to be incident on the light receiving lens 16.

In S702, the CPU 3 performs image capturing by the image capturing element for eyeball 17. The ocular image formed by the light receiving lens 16 is converted into an image signal by the image capturing element for eyeball 17. The image signal is A/D converted by the line-of-sight detection circuit 201 and input as ocular image data to the CPU 3.

In S703, the CPU 3 calculates coordinates of corneal reflection images Pd′ and Pe′ of the illumination light sources 13a and 13b and coordinates of an image c′ at a pupil center c from the ocular image data obtained in S702.

The ocular image obtained by the image capturing element for eyeball 17 contains the corneal reflection images Pd′ and Pe′ corresponding to images Pd and Pe of the illumination light sources 13a and 13b reflected on a cornea 142 (FIG. 6A). Herein, it is assumed that there is a single combination (P-image pair) of corneal reflection images contained in the ocular image.

As illustrated in FIG. 6A, the horizontal direction is set as the X axis, and the vertical direction is set as the Y axis. At this time, X axis coordinates of the center of the corneal reflection images Pd′ and Pe′ of the illumination light sources 13a and 13b, which are contained in the ocular image, are denoted as Xd and Xe. In addition, X axis coordinates of images a′ and b′ of pupil edges a and b that are end portions of a pupil 141 are denoted as Xa and Xb.

As illustrated in FIG. 6B, luminance of the coordinates Xd and Xe, equivalent to the corneal reflection images Pd′ and Pe′ of the illumination light sources 13a and 13b, is very high relative to luminance at other positions. On the other hand, luminance in a range from the coordinate Xa to the coordinate Xb, which is equivalent to the area of the pupil 141, is very low except for the coordinates Xd and Xe. In addition, luminance in a range with the coordinate smaller than Xa and a range with the coordinate larger than Xb, which are equivalent to the area of an iris 143 outside the pupil 141, is intermediate luminance between the luminance of the corneal reflection image of the illumination light source and the luminance of the pupil.

The CPU 3 can detect, based on such a characteristic of the luminance level in the X axis direction, the X axis coordinates Xd and Xe of the corneal reflection images Pd′ and Pe′ of the illumination light sources 13a and 13b and the X axis coordinate Xa, Xb of the images a′ and b′ of the pupil edges a and b from the ocular image. In addition, for such a use as in the present embodiment, a rotation angle θx of the optical axis of the eyeball 14 with respect to the optical axis of the light receiving lens 16 is relatively small. In such a case, an X axis coordinate Xc of the image c′ at the pupil center c in the ocular image can be represented by Xc≈(Xa+Xb)/2. In this manner, the CPU 3 can calculate the coordinates of the corneal reflection images Pd′ and Pe′ of the illumination light sources 13a and 13b and the X axis coordinate of the image c′ at the pupil center c from the ocular image.

In S704, the CPU 3 calculates an imaging magnification β of the ocular image. Here, B is a magnification decided by the position of the eyeball 14 relative to the light receiving lens 16 and can be calculated as a function of an interval (Xd-Xe) of the corneal reflection images Pd′ and Pe′ of the illumination light sources.

In S705, the CPU 3 calculates rotation angles of the eyeball. An X axis coordinate at a midpoint of the images Pd and Pe of the illumination light sources on the cornea 142 substantially matches an X axis coordinate of a center of curvature O of the cornea 142. For this reason, when a standard distance from the center of curvature O of the cornea 142 to the center c of the pupil 141 is denoted as Oc, the rotation angle θx in a Z-X plane of the optical axis of the eyeball 14 can be calculated from a relationship equation of β*Oc*SIN θx≈{(Xd+Xe)/2}−Xc.

FIG. 5 and FIGS. 6A and 6B illustrate examples in which the rotation angle θx in the plane (Z-X plane) perpendicular to the Y axis is calculated, but the rotation angle θy in a plane (Z-Y plane) perpendicular to the X axis can also be similarly calculated. In this manner, the CPU 3 calculates the rotation angles θx and θy of the eyeball. Then, the line-of-sight position can be calculated based on these rotation angles of the eyeball.

In S706, the CPU 3 obtains correction coefficients (Ax, Bx, Ay, By) from the memory unit 4. The correction coefficients are coefficients for correcting an individual difference such as a shape of the eyeball of the user. The correction coefficients are calculated by calibration processing and stored in the memory unit 4 before the line-of-sight detection processing of FIG. 7 is started. In a case where the memory unit 4 stores the correction coefficients with regard to a plurality of users, the correction coefficients corresponding to the current user are used, for example, by asking the user or the like at any timing. A calculation method for the correction coefficients by the calibration processing will be described below.

In S707, the CPU 3 calculates line-of-sight coordinates (line-of-sight position) of the user on the display element 10 by using the rotation angle θx and θy of the eyeball calculated in S705. In addition, the line-of-sight position of the user can be calculated by equations of Hx=m×(Ax×θx+Bx) and Hy=m×(Ay×θy+By) as coordinates (Hx, Hy) corresponding to the center c of the pupil 141 on the display element 10.

Herein, a coefficient m is a conversion coefficient for converting the rotation angles θx and θy into the coordinates corresponding to the center c of the pupil 141 on the display element 10 and set by a characteristic of the eyepiece lens 12 of the viewfinder optical system of the camera. The coefficient m can be stored in the memory unit 4 in advance. In addition, Ax, Bx, Ay, and By are the correction coefficients obtained in S706.

In S709, the CPU 3 records the line-of-sight position (Hx, Hy) and a time (line-of-sight detection time) at which the ocular image data is obtained in S702 in the memory unit 4 and ends the line-of-sight detection processing.

As described above, the line-of-sight position (Hx, Hy) is calculated by obtaining the imaging magnification β of the ocular image from the single P-image pair (corneal reflection images Pd′ and Pe′) and obtaining the rotation angles θx and θy of the eyeball from the imaging magnification β. In this manner, in a case where only a single P-image pair exists, the line-of-sight position may be calculated from the P-image pair. However, when the number of lit illumination light sources increases, the number of corneal reflection images also increases. In such a case, the number of combinations (P-image pairs) of corneal reflection images corresponding to the number of lit illumination light sources also increases. Specifically, when the number of lit illumination light sources increases to 2, 3, 4, and so on, the number of P-image pairs increases as in ₙC₂ (n=the number of lit illumination light sources, n≥2). When the line-of-sight position is calculated from each of the plurality of P-image pairs, a time period spent for the line-of-sight detection processing increases. In view of the above, it is demanded that even when the number of lit illumination light sources increases, the time period spent for the line-of-sight detection processing is not increased and the accuracy of the line-of-sight position detected by the line-of-sight detection processing is not also reduced.

According to the present embodiment, during the calibration processing, from among the plurality of P-image pairs, the P-image pairs are rearranged in order of accuracy for calculating the line-of-sight position, and the order is stored. In addition, a time limit in a case where the line-of-sight detection processing is performed is set as a predetermined time period, and the line-of-sight detection processing is performed within this predetermined time period. Then, when the line-of-sight detection processing is executed, the line-of-sight position is calculated in the order of the stored P-image pairs. With this configuration, even when the calculation using all the P-image pairs is not completed within the predetermined time period, the accuracy of the line-of-sight position detected by the line-of-sight detection processing is less likely to be reduced, and the line-of-sight detection processing can be executed in the predetermined time period. It is noted that even when rearrangement of the P-image pair is not performed, an order may be set for the P-image pairs, and the line-of-sight position may be calculated in the set order of the P-image pairs. In addition, when the user sets a priority on a speed of the line-of-sight detection processing, the line-of-sight position may be calculated in the order of the P-image pairs stored during the calibration processing. In the above-described case, when the user does not set a priority on the speed of the line-of-sight detection processing, the line-of-sight position is calculated in an order that is not based on the order of the P-image pairs stored during the calibration processing.

### Calibration Processing

The calibration processing is a process for more accurately detecting the line-of-sight position corresponding to the line of sight of the user. That is, the calibration processing is a process for improving the detection accuracy of the line of sight. There is an individual difference in a structure of an entire eye such as a shape of an eyeball of a user, and it may be difficult to decide the line-of-sight position corresponding to the line of sight depending on the user. For example, as in FIG. 4B, a discrepancy may occur between the line-of-sight position B where the user is actually viewing and the estimated line-of-sight position C detected by the line-of-sight detection processing. In the above-described case, even when it is desired to perform the AF processing at the position of the person based on the line-of-sight position, when the line-of-sight position detected by the line-of-sight detection processing is in a background, the AF processing is performed at the position in the background. As a result, the AF processing is performed at a position that is not a position intended by the user.

In view of the above, by performing the calibration processing, it is possible to obtain line-of-sight data that is the line-of-sight information unique to the user who uses the camera 1. By calculating the correction coefficients (Ax, Bx, Ay, By) based on the obtained line-of-sight data unique to the user, it is possible to more accurately decide the line-of-sight position corresponding to the line of sight of the user.

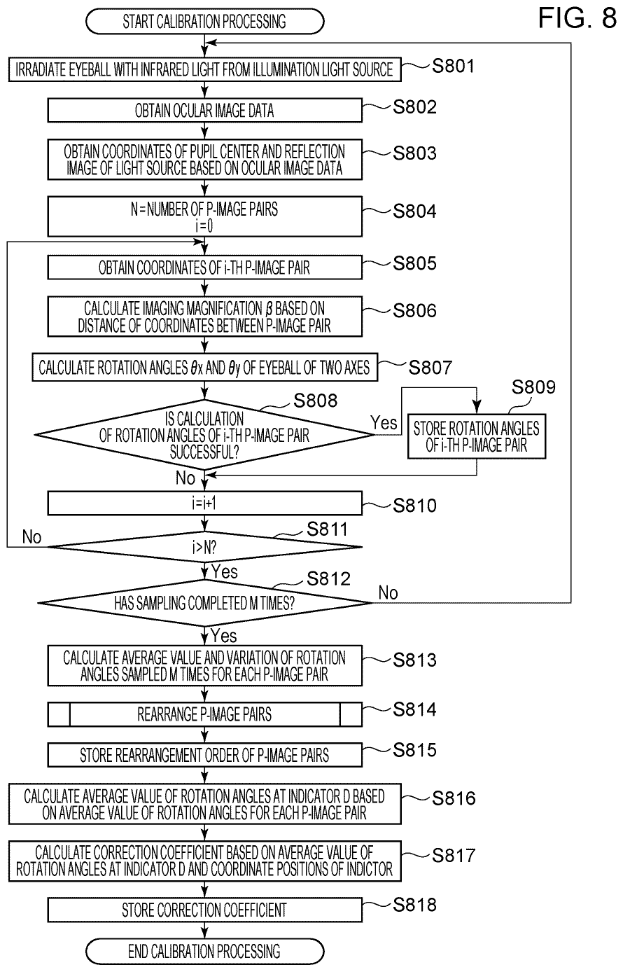

According to the present embodiment, in the calibration processing, the correction coefficients (Ax, Bx, Ay, By) are calculated, and also in a case where the plurality of P-image pairs are contained in the ocular image, the P-image pairs are rearranged in order of accuracy for calculating the line-of-sight position, and the order is stored. This calibration processing will be described in detail with reference to a flowchart of FIG. 8.

The calibration processing is a process in a case where the camera 1 is activated, and a calibration execution instruction (selection of a setting item to “perform” calibration) is issued in a setting menu screen. In a case where the calibration execution instruction is issued, the viewfinder image of FIG. 4C is displayed, and an indicator D to an indicator G to which the user pays attention are highlighted for display in order, and the calibration processing is executed during highlight display of each indicator. For example, the calibration processing of FIG. 8 represents a process executed corresponding to the indicator D among the indicator D to the indicator G but is a process respectively executed during highlight display of indicators other than the indicator D. This calibration processing is executed when the CPU 3 controls each unit.

In S801, the CPU 3 causes the illumination light sources 13a to 13c to turn on through the illumination light source driving circuit 205. With this configuration, infrared light is emitted towards the outside of the camera main unit 1B from the illumination light source. The infrared light is reflected by the eyeball of the user who looks into the eyepiece lens 12 and is further reflected by the beam splitter 15 to be incident on the light receiving lens 16.

In S802, the CPU 3 performs image capturing by the image capturing element for eyeball 17. The ocular image formed by the light receiving lens 16 is converted into the image signal by the image capturing element for eyeball 17. The image signal is A/D converted by the line-of-sight detection circuit 201 and is input as the ocular image data to the CPU 3.

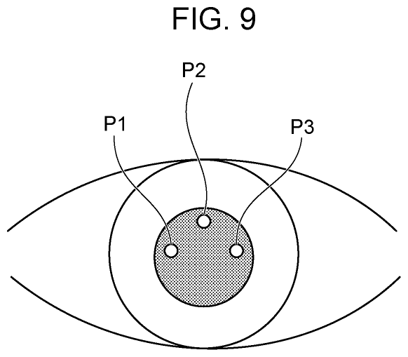

In S803, the CPU 3 obtains coordinates of corneal reflection images P1, P2, and P3 of the illumination light sources and coordinates of the image c′ at the pupil center c based on the ocular image data obtained in S802. FIG. 9 illustrates a situation where the three corneal reflection images (P1 to P3) are projected onto the eyeball. In a case where the three corneal reflection images are projected in this manner, combinations (P-image pairs) of these corneal reflection images are three combinations of P1 and P2, P2 and P3, and P1 and P3. According to the present embodiment, a case will be described where the three corneal reflection images are projected onto the eyeball, but in a case where n (≥3) corneal reflection images are projected, the number of P-image pairs can be calculated by an equation of nCr=n!/r!(n−r)!.

In S804, the CPU 3 assigns the total number of P-image pairs to a variable N (N≥2) as an initial value and assigns “0” to a variable i.

In S805, the CPU 3 obtains coordinates of the i-th P-image pair. The order of the P-image pairs for obtaining the coordinates is decided by the user in advance, and for example, decided as ascending order of an impact by an eyelid of the user on the corneal reflection images. It is noted that in a case where the calibration processing is performed for the first time, coordinates of the P-image pairs may be obtained in the order decided by the user in advance. However, in a case where the calibration processing is not performed for the first time, coordinates of the P-image pair may be obtained in the order of the P-image pairs rearranged by the last calibration processing. Herein, the first P-image pair are set as P1 and P2, and the X axis coordinates at the center of P1 and P2 are respectively set as X1 and X2.

In S806, the CPU 3 calculates the imaging magnification β of the ocular image. Here, β is a magnification decided by the position of the eyeball 14 relative to the light receiving lens 16, for example, and can be calculated as a function of a distance (X1-X2) of coordinates of P1 and P2 that are the first P-image pair.

In S807, the CPU 3 calculates the rotation angles of the eyeball. The X axis coordinate at the midpoint of the images P1 and P2 of the illumination light source on the cornea 142 and the X axis coordinate at the center of curvature O of the cornea 142 substantially match. For this reason, when the standard distance from the center of curvature O of the cornea 142 to the center c of the pupil 141 is denoted as Oc, the rotation angle θx in the Z-X plane of the optical axis of the eyeball 14 can be calculated from a relationship equation of β*Oc*SIN θx≈{(X1+X2)/2}−Xc. In addition, the rotation angle θy in the plane (Z-Y plane) perpendicular to the X axis can also be similarly calculated. In this manner, the CPU 3 calculates the rotation angles θx and θy of the eyeball.

In S808, the CPU 3 determines whether or not the calculation of the rotation angles of the i-th P-image pair is successful. In a case where it is determined that the calculation of the rotation angles of the i-th P-image pair is successful, the flow proceeds to S809, and in a case where it is determined that the calculation is not successful, the flow proceeds to S810. For example, when the coordinates of the pupil center can be detected based on the ocular image data obtained in S802, it is assumed that the calculation of the rotation angles of the i-th P-image pair is successful. In addition, the rotation angles of the i-th P-image pair are calculated by sampling repeatedly performed. When the rotation angles of the i-th P-image pair are values that deviate by a predetermined value or more as compared with results of the sampling repeatedly performed, it is assumed that the calculation of the rotation angles of the i-th P-image pair fails.

In S809, the CPU 3 stores the rotation angles of the i-th P-image pair in the memory unit 4. It is noted that according to the present embodiment, only the rotation angles of the P-image pair in which the calculation of the rotation angles is successful are stored in the memory unit 4, but information related to not only the P-image pair in which the calculation of the rotation angles is successful but also the P-image pair in which the calculation of the rotation angles fails may be stored in the memory unit 4. In the above-described case, a determination result on whether each of the P-image pairs is a P-image pair in which the calculation of the rotation angles is successful or a P-image pair in which the calculation of the rotation angles fails is preferably stored in the memory unit 4 as information related to the P-image pair.

In S810, the CPU 3 sets i=i+1.

In S811, the CPU 3 determines whether or not i>N. In a case where it is determined that i>N, the flow proceeds to S812, and in a case where it is not determined that i>N, the flow proceeds to S805.

In S812, the CPU 3 determines whether or not sampling has completed the predetermined number M of times (≥2). Sampling M times means that the rotation angles are repeatedly calculated.

In a case where it is determined that sampling has completed M times, that is, repeatedly, the flow proceeds to S813, and in a case where it is not determined that sampling has completed M times, the flow proceeds to S801.

In S813, for each P-image pair for which the rotation angles are stored, the CPU 3 calculates the average value and the variation of the rotation angles sampled M times. When it is determined that the calculation of the rotation angles is successful in all the sampling performed M times, average values Avθx and Avθy of the rotation angles can be calculated by the following equations.

$$A v θ x = \frac{1}{M} {\sum }_{i = 1}^{m} θ xi , and \qquad ( 1 )$$

$$Av θ y = \frac{1}{M} {\sum }_{i = 1}^{m} θ yi .$$

In addition, with regard to the variation, when it is determined that the calculation of the rotation angles is successful in all the sampling performed M times, variances Vθx and Vθy of the rotation angles can be calculated by the following equations.

$$V θ x = \frac{1}{M} {\sum }_{i = 1}^{m} {( θ xi - Av θ x )}^{2} , and \qquad ( 2 )$$

$$V θ y = \frac{1}{M} {\sum }_{i = 1}^{m} {( θ yi - Av θ y )}^{2} .$$

It is noted that in S813, the calculation processing is not performed with regard to the P-image pair in which it is determined in S808 that the calculation of the rotation angles is not successful.

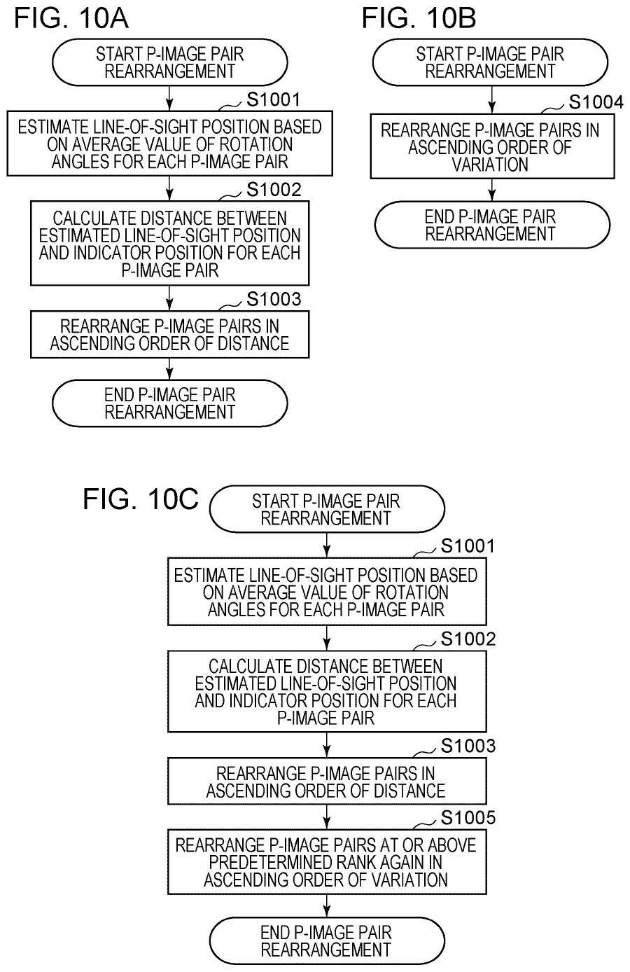

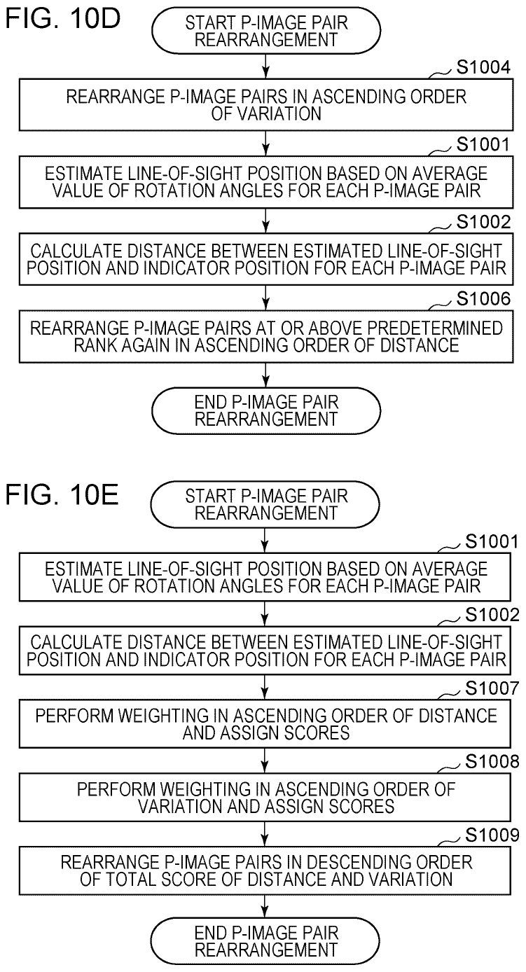

In S814, the CPU 3 executes a subroutine of rearranging, based on the average value and the variation of the rotation angles calculated in S813, P-image pairs in order of accuracy for calculating the line-of-sight position, and the flow proceeds to S815. The subroutine of rearranging the P-image pairs will be described below with reference to FIGS. 10A to 10E.

In S815, the CPU 3 stores the order of the P-image pairs after the rearrangement processing of the P-image pairs is performed in the memory unit 4, and the flow proceeds to S816.

In S816, the CPU 3 calculates average values of the rotation angles in the indicator D based on the average values of the rotation angles for each P-image pair. Specifically, the average values θxd and θyd of the rotation angles in the indicator D are calculated based on the average values of the rotation angles calculated from each of the three P-image pairs of P1 and P2, P2 and P3, and P1 and P3.

In S817, the correction coefficients are calculated based on the average values θxd and θyd of the rotation angles in the indicator D and the position (Hxd, Hyd) of the coordinates of the indicator D by equations of Hxd=m×(Ax×θxd+Bx) and Hyd=m×(Ay×θyd+By). Herein, the coefficient m is a conversion coefficient for converting the rotation angles θxd and θyd into the coordinates corresponding to the center c of the pupil 141 on the display element 10 and is set by the characteristic of the eyepiece lens 12 of the viewfinder optical system of the camera.

In S818, the correction coefficients (Ax, Ay, Bx, By) calculated in S817 are stored in the memory unit 4, and the calibration processing is ended.

### Subroutine of Rearrangement of P-Image Pairs

FIGS. 10A to 10E are flowcharts related to subroutines of rearranging the P-image pairs. A method of rearranging the P-image pairs includes five ways as illustrated in FIGS. 10A to 10E, and those will be described.

In FIG. 10A, in S1001, the CPU 3 estimates the line-of-sight position (Hx, Hy) based on the average values of the rotation angles calculated in S813 for each P-image pair. The line-of-sight position (Hx, Hy) is calculated by the equations of Hx=m×(Ax×Avθx+Bx) and Hy=m×(Ay×Avθy+By), but at this time, the correction coefficients (Ax, Ay, Bx, By) are any values.

In S1002, the CPU 3 calculates a distance between the line-of-sight position (Hx, Hy) estimated in S1001 and a position (Hxd, Hxy) of coordinates of the indicator for each P-image pair. The distance between the estimated line-of-sight position and the position of the coordinates of the indicator may be a distance in the X axis direction, a distance in the Y axis direction, or another Euclidean distance.

In S1003, the CPU 3 executes rearrangement of the P-image pairs in ascending order of the distance calculated in S1002, and the subroutine of rearranging the P-image pairs is ended.

In FIG. 10B, in S1004, the CPU 3 executes rearrangement of the P-image pairs in ascending order of the variation calculated in S813 for each P-image pair, and the subroutine of rearranging the P-image pairs is ended.

In FIG. 10C, the processing in S1001 to S1003 is similar to the processing of FIG. 10A. In S1005, the CPU 3 rearranges the P-image pairs at or above a predetermined rank again in ascending order of the variation in the P-image pairs rearranged in S1003, and the subroutine of rearranging the P-image pairs is ended.

In FIG. 10D, the processing in S1001 and S1002 is similar to the processing of FIG. 10A, and the processing in S1004 is similar to the processing of FIG. 10B. In S1006, the CPU 3 rearranges the P-image pairs at or above the predetermined rank in ascending order of the distance in the P-image pairs rearranged in S1004, and the subroutine of rearranging the P-image pairs is ended.

In FIG. 10E, the processing in S1001 and S1002 is similar to the processing of FIG. 10A. In S1007, the CPU 3 performs weighting in ascending order of the distance calculated in S1002 and assigns a score for each P-image pair.

In S1008, the CPU 3 performs weighting in ascending order of the variation calculated in S813 for each P-image pair and assigns a score for each P-image pair. The method for the weighting may be the same as S1007.

In S1009, the CPU 3 rearranges the P-image pairs in descending order of the total score of the distance and the variation, and the subroutine of rearranging the P-image pairs is ended.

Flowchart Related to Line-of-Sight Detection Processing in a Case where there are a Plurality of P-Image Pairs

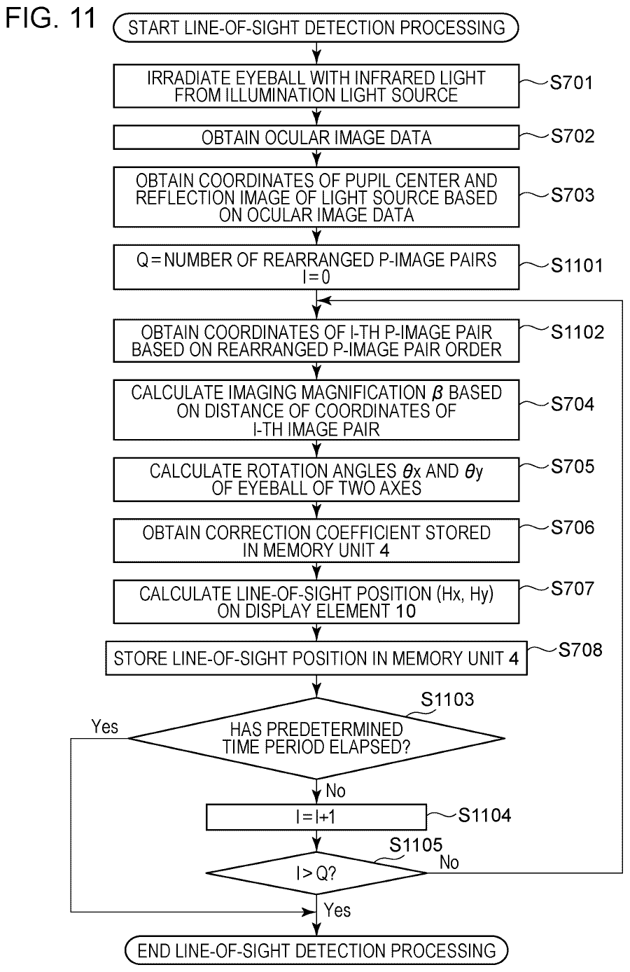

FIG. 11 is a flowchart related to the line-of-sight detection processing in a case where there are a plurality of combinations (P-image pairs) of the corneal reflection images contained in the ocular image according to the present embodiment. The line-of-sight detection processing can be executed, for example, when an object is in proximity to the eyepiece lens 12. Proximity of the object to the eyepiece lens 12 can be sensed by any method in related art, such as using, for example, a proximity sensor provided near the eyepiece lens 12. The line-of-sight detection processing may be started in response to an instruction of the user through the operation unit 204. The processing of FIG. 11 is executed when the CPU 3 controls each unit. A description on the processing similar to the flowchart of FIG. 7 is omitted.

In S1101, the CPU 3 assigns the total number of P-image pairs used in the line-of-sight detection processing performed this time to a variable Q (Q≥2) as an initial value and assigns “0” to a variable 1. Herein, the number of P-image pairs after the order is rearranged is the total number of P-image pairs.

In S1102, the CPU 3 obtains coordinates of the l-th P-image pair based on the order of the P-image pairs after rearrangement. The order of the P-image pairs for obtaining coordinates is the order after rearrangement stored in the memory unit 4 in S815.

In S1103, the CPU 3 determines whether or not a predetermined time period set in advance as a time period spent for the line-of-sight detection processing has elapsed. When it is determined that the predetermined time period set in advance has elapsed, the flow does not proceed to S1104, and the line-of-sight detection processing is ended. On the other hand, when it is determined that the predetermined time period set in advance has not elapsed, the flow proceeds to S1104. With this configuration, the line-of-sight detection processing is ended within the predetermined time period set in advance, and also the accuracy of the line-of-sight detection is hardly reduced.

In S1104, the CPU 3 sets 1=1+1.

In S1105, the CPU 3 determines whether or not 1>Q. In a case where it is determined that 1>Q, the line-of-sight detection processing is ended, and in a case where it is not determined that 1>Q, the flow proceeds to S1102. In a case where the P-image pair in which the calculation of the rotation angles is not successful exists in the calibration processing, the number of P-image pairs after rearrangement is small. In the above-described case, before the predetermined time period has elapsed, the line-of-sight detection processing may be completed for Q P-image pairs. In such a case, Yes is determined in S1105.

With this configuration, the line-of-sight position (Hx, Hy) on the display element 10 is calculated based on each of the plurality of P-image pairs. Then, an average value obtained when these line-of-sight positions are all added up to be divided by the number of P-image pairs is calculated as a single line-of-sight position, and based on the line-of-sight position, a pointer indicating the line-of-sight position is displayed, or a position of the AF frame is decided. An average value of the line-of-sight position (Hx, Hy) calculated from each of the plurality of P-image pairs is calculated as the single line-of-sight position, but a median value of the P-image pair of the line-of-sight position (Hx, Hy) calculated from each of the plurality of P-image pairs may be calculated as the single line-of-sight position. In addition, among the line-of-sight position (Hx, Hy) calculated from each of the plurality of P-image pairs, the line-of-sight position at a distance closest to the line-of-sight position calculated in the previous frame may be used as the line-of-sight position for pointer display or decision of the position of the AF frame.

### Second Embodiment

According to the first embodiment, the example has been described in which the technique is applied to the digital still camera 1 as the electronic device but can also be applied to an HMD. As a second embodiment, the HMD will be described.

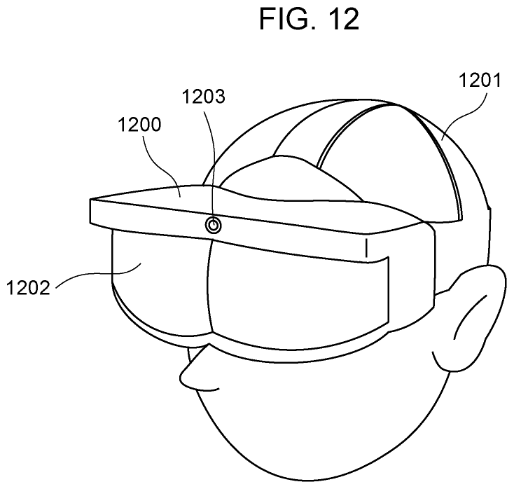

FIG. 12 is a perspective view illustrating an external appearance example of a head mount display (HMD) that is an example of an electronic device according to a second embodiment. An HMD 1200 illustrated in FIG. 12 is a display device mounted to a head part of the user. The HMD 1200 is provided with an operation member capable of performing an apparatus operation, such as a power supply switch or a button for controlling an apparatus setting, an image processing unit configured to function as an image processing apparatus and to, for example, generate a virtual object or combine images, and the like. A head-mounted member 1201 is provided to stably fix the HMD 1200 to a head of the user such that the HMD 1200 can operate in accordance with a movement of the head part of the user without misalignment. It is noted that the head-mounted member has a configuration to be fixed to the head part of the user but may have a configuration to be fixed while being hung over an ear of the user or supported by a hand.

A display device 1202 provides, in front of an eye of the user who is a wearer, a virtual object or a combined image of a real image and a virtual object. The display device 1202 may be, for example, a liquid crystal display or an organic EL display. The display device 1202 is constituted by a liquid crystal panel, a driver circuit configured to drive the liquid crystal panel, and a memory configured to hold an image to be displayed, for example. The display device 1202 may be a non-transmission type display unit or may be an optical transmission type display unit in which an external view can also be directly visually recognized.

An image capturing apparatus 1203 is an apparatus (camera unit) configured to capture an image of an environment around the user.

The image capturing apparatus 1203 may capture an image of an environment in front of the user as an environment around the user. An area in front of the user may be a front of the head part of the user.

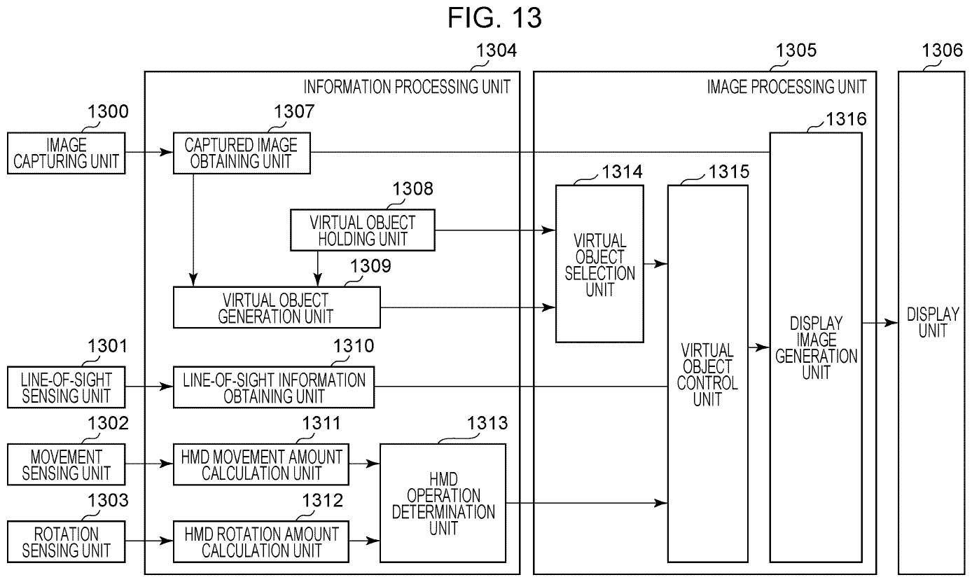

FIG. 13 is a block diagram illustrating a system configuration example of the HMD that is an example of an electronic device according to the second embodiment.

The HMD illustrated in FIG. 13 is constituted by an image capturing unit 1300, a line-of-sight sensing unit 1301, a movement sensing unit 1302, a rotation sensing unit 1303, an information processing unit 1304, an image processing unit 1305, and a display unit 1306.

The information processing unit 1304 is constituted by a captured image obtaining unit 1307, a virtual object holding unit 1308, a virtual object generation unit 1309, a line-of-sight information obtaining unit 1310, an HMD movement amount calculation unit 1311, an HMD rotation amount calculation unit 1312, and an HMD operation determination unit 1313.

The image processing unit 1305 is constituted by a virtual object selection unit 1314, a virtual object control unit 1315, and a display image generation unit 1316. A description of each block will be described below. In addition, although not illustrated in the drawing, processing performed by the image processing unit 1305 includes pre-processing, color interpolation processing, correction processing, detection processing, data processing, and the like. The pre-processing includes signal amplification, reference level adjustment, defective pixel correction, and the like. The color interpolation processing is a process of interpolating a value of a color component that is not contained in image data and is also referred to as de-mosaic processing. The correction processing includes white balance adjustment, processing of correcting a luminance of an image, processing of correcting an optical aberration of an imaging lens (not illustrated), processing of correcting a color, and the like. The detection processing includes detection and tracking processing of a feature area (for example, a face area, a human body area, an animal, an automobile, or the like), recognition processing of a person, and the like. In addition, the image processing unit 1305 can obtain, by analyzing a difference in image data over time, information on a movement characteristic of a subject, such as how the subject in the image data is moving within an image plane. The data processing includes scaling processing, encoding and decoding processing, header information generation processing, and the like. It is noted that these types of processing are examples of image processing that can be implemented by the image processing unit 1305 and do not limit image processing implemented by the image processing unit 1305.

The image capturing unit 1300 is constituted by an optical system, an image sensor, a driver circuit configured to control the image sensor, an A/D conversion circuit configured to convert a signal obtained by the image sensor into a digital signal, and a development circuit configured to develop the obtained signal as an image. Image data captured by the image capturing unit 1300 is obtained by the captured image obtaining unit 1307 of the information processing unit 1304 and transmitted to the display image generation unit 1316 of the image processing unit 1305. In the display image generation unit 1316, combination processing with a virtual object which will be described below is performed to generate a display image. In addition, the captured image obtaining unit 1307 transfers the captured image to the virtual object generation unit 1309 to cause a virtual object to be generated.

The line-of-sight sensing unit 1301 is an apparatus configured to detect a line-of-sight direction of the user who is the wearer. For example, the line-of-sight sensing unit 1301 may be an apparatus configured to irradiate the eyeball of the user by an infrared light emitting diode, which is used in a single lens reflex camera or the like in related art, and detect the line-of-sight direction based on a relationship between a corneal reflection image (P-image) by corneal reflection of a light source and the pupil.

The line-of-sight information sensed by the line-of-sight sensing unit 1301 is obtained by the line-of-sight information obtaining unit 1310 of the information processing unit 1304 and is transmitted to the virtual object control unit 1315 of the image processing unit 1305.

In the virtual object control unit 1315, the virtual object which will be described below is controlled and transmitted to the display image generation unit 1316 of the image processing unit 1305. In the display image generation unit 1316, combination processing is performed with the captured image to generate a display image.

The movement sensing unit 1302 is an apparatus configured to detect a movement of the HMD. Movement information sensed by the movement sensing unit 1302 is obtained by calculating a movement amount by the HMD movement amount calculation unit 1311 of the information processing unit 1304 and is transferred to the HMD operation determination unit 1313. The movement sensing unit 1302 is an HMD movement detection unit and is configured to detect a movement of the HMD by using position information of a global positioning system (GPS) or a movement detection unit, such as an acceleration sensor.

The rotation sensing unit 1303 is an apparatus configured to detect a rotation of the HMD. The rotation information sensed by the rotation sensing unit 1303 is obtained by calculating a rotation amount by the HMD rotation amount calculation unit 1312 of the information processing unit 1304 and is transferred to the HMD operation determination unit 1313. The rotation sensing unit 1303 is an HMD rotation detection unit and is configured to detect the rotation of the HMD by using a rotational displacement sensor.

The HMD operation determination unit 1313 determines an operation of the HMD based on the movement direction and the movement amount of the HMD and on the rotation direction and the rotation amount of the HMD from the movement information of the HMD transferred from the HMD movement amount calculation unit 1311 and the rotation information of the HMD transferred from the HMD rotation amount calculation unit 1312. Operation information determined by the HMD operation determination unit 1313 is transferred to the virtual object control unit 1315 of the image processing unit 1305.

The virtual object holding unit 1308 holds data of a virtual space, such as data related to a virtual item constituting a virtual space (shape information or position and posture information) or data related to a light source for irradiation in the virtual space. Then, the virtual object selection unit 1314 of the image processing unit 1305 selects a virtual object to be transferred to the virtual object control unit 1315. In addition, the virtual object holding unit 1308 transfers the virtual object to the virtual object generation unit 1309 to cause another virtual object to be generated.

The virtual object generation unit 1309 generates a virtual object based on the image data transferred from the captured image obtaining unit 1307 and the virtual object data transferred from the virtual object holding unit 1308. Then, the generated virtual object is transferred to the virtual object selection unit 1314 of the image processing unit 1305.

The virtual object selection unit 1314 selects a virtual object to be displayed for the user by the virtual object holding unit 1308 and the virtual object generation unit 1309 and causes the selected virtual object to be transferred to the virtual object control unit 1315 as the virtual object to be displayed. It is noted that virtual object data to be displayed is data including display image data, arrangement position data at a display field of view, overlapping order data with each virtual object, and the like.

The virtual object control unit 1315 controls the virtual object data transferred from the virtual object selection unit 1314 based on the line-of-sight information transferred from the line-of-sight information obtaining unit 1310 and the operation information of the HMD transferred from the HMD operation determination unit 1313. Then, the virtual object control unit 1315 transfers the virtual object data to the display image generation unit 1316.

The display image generation unit 1316 creates a combined image of the captured image data transferred from the captured image obtaining unit 1307 and the virtual object transferred from the virtual object control unit 1315 and transfers the combined image to the display unit 1306.

### OTHER EMBODIMENTS

The above-described various types of control performed by the CPU 3 may be performed by a single piece of hardware, or control of the entire apparatus may be performed while a plurality of pieces of hardware (for example, a plurality of processors or circuits) share the processing.

In addition, the present disclosure has been described in detail based on example embodiments, but the some embodiments are not limited to these example embodiments, and various modes within a range that does not depart from the gist of this disclosure are also included in some embodiments. Furthermore, each of the above-described embodiments merely illustrates an example embodiment of the present disclosure, and each embodiment can also be appropriately combined.

According to the present disclosure, in a case where there are a plurality of combinations (P-image pairs) of corneal reflection images contained in the ocular image, even when the time period spent for the line-of-sight detection processing is the predetermined time period, the line-of-sight detection accuracy is hardly reduced.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-207380, which was filed on Nov. 28, 2024 and which is hereby incorporated by reference herein in its entirety.

What is claimed is:

1. An electronic device comprising:
a plurality of irradiation units configured to irradiate an eyeball of a user with infrared light;
an image capturing unit configured to capture an ocular image obtained when the infrared light from the plurality of irradiation units is reflected by the eyeball;
one or more memories; and
one or more processors in communication with the one or more memories, wherein the one or more processors and the one or more memories are configured to:
calculate a line-of-sight position of the user who looks into a display unit based on combinations of a plurality of corneal reflection images contained in the ocular image; and
set an order with regard to each of the combinations of the plurality of corneal reflection images based on a predetermined condition during calibration processing for improving a calculation accuracy of the line-of-sight position,
wherein
processing using the combinations of the plurality of corneal reflection images is performed based on the set order within a predetermined time period to calculate the line-of-sight position of the user who looks into the display unit.

2. The electronic device according to claim 1, wherein processing is performed using the combinations of the plurality of corneal reflection images in a predetermined order during the calibration processing, and based on a result of the processing and the predetermined condition, the order of the combinations of the plurality of corneal reflection images is set by rearranging the order from the predetermined order.

3. The electronic device according to claim 1, wherein
the calibration processing includes calculating rotation angles of the eyeball by repeatedly calculating a rotation angle of the eyeball based on coordinates of the combinations of the plurality of corneal reflection images with regard to each of the combinations of the plurality of corneal reflection images, and
an average value of the rotation angles of the eyeball and a variation of the rotation angles of the eyeball are calculated with regard to each of the combinations of the plurality of corneal reflection images.

4. The electronic device according to claim 3, wherein the predetermined condition is a condition based on the calculated average value of the rotation angles of the eyeball or the calculated variation of the rotation angles of the eyeball.

5. The electronic device according to claim 4, wherein the predetermined condition is a magnitude of a distance between the line-of-sight position estimated based on the calculated average value of the rotation angles of the eyeball and an indicator displayed on the display unit during the calibration processing.

6. The electronic device according to claim 4, wherein the predetermined condition is a magnitude of the calculated variation of the rotation angles of the eyeball.

7. A control method for an electronic device, the control method comprising:
capturing an ocular image obtained when infrared light from a plurality of irradiation units configured to irradiate an eyeball of a user with infrared light is reflected by the eyeball;
calculating a line-of-sight position of the user who looks into a display unit based on combinations of a plurality of corneal reflection images contained in the ocular image; and
setting an order with regard to each of the combinations of the plurality of corneal reflection images based on a predetermined condition during calibration processing for improving a calculation accuracy of the line-of-sight position, wherein
in the calculating, processing using the combinations of the plurality of corneal reflection images is performed based on the order set in the setting within a predetermined time period to calculate the line-of-sight position of the user who looks into the display unit.

8. A non-transitory computer-readable medium that stores instructions for causing a computer to execute a control method comprising:
capturing an ocular image obtained when infrared light from a plurality of irradiation units configured to irradiate an eyeball of a user with infrared light is reflected by the eyeball;
calculating a line-of-sight position of the user who looks into a display unit based on combinations of a plurality of corneal reflection images contained in the ocular image; and
setting an order with regard to each of the combinations of the plurality of corneal reflection images based on a predetermined condition during calibration processing for improving a calculation accuracy of the line-of-sight position, wherein
in the calculating, processing using the combinations of the plurality of corneal reflection images is performed based on the order set in the setting within a predetermined time period to calculate the line-of-sight position of the user who looks into the display unit.
